(19) United States
(12) Patent Application Publication
(10) Pub. No.: US 2004/0213368 A1
(43) Pub. Date: Oct. 28, 2004

(54) FUSION REACTOR THAT PRODUCES NET POWER FROM THE P-B11 REACTION

(76) Inventors: NORMAN ROSTOKER, IRVINE, CA (US); HENDRIK J. MONKHORST, GAINESVILLE, FL (US)

Correspondence Address: ORRICK, HERRINGTON & SUTCLIFFE, LLP, 4 PARK PLAZA, SUITE 1600, IRVINE, CA, 92614-2558, US

(21) Appl. No.: 08/527,176

(22) Filed: Sep. 11, 1995

(51) Int. Cl. G21B 1/00; G21J 1/00

(52) U.S. Cl. 376/107

(57) ABSTRACT

Ionized boron and protons are used a nuclear reactants in a field-reversed configuration system, and fuse to yield three alpha particles with kinetic energy convertible to useful energy. The boron and proton beams are injected into the reaction chamber in such a manner as to have a relative energy of 0.65 MeV, corresponding to a resonance maximum in the reaction cross-section. The boron beam has energy of 0.412 MeV and the proton beam has energy of 1 MeV. Furthermore, in the device of the invention, the beams tend to circulate in the same direction, thereby avoiding rapid change in the mean velocities of the beams due to ion-ion scattering. The ions remain confined for relatively long periods, enhancing fusion collisions. Both ion beams should not have temperatures greater than 100 keV, because this will detract from the resonance in cross-section.

This invention was made with Government support under Contract No. MP-94-04; B283616, awarded by the Department of Energy and Grant No. N00014-90-J-1675, awarded by the Office of Naval Research. The Government has certain rights in this invention.

### BACKGROUND OF THE INVENTION

1. Field of the Invention

The present invention relates to fusion devices and methods and more particularly to a fusion reactor wherein protons and ionized boron beams are injected into a confining magnetic field at beam velocities selected to cause the beams to be trapped in orbits with optimal reaction cross-sections for release of energy in spontaneous fusion reactions.

2. Description of the Prior Art

Various fusion devices based on various confinement configuration principles are known wherein plasma is generated in a reaction chamber and confined magnetically. The plasma is heated by various methods, such as ohmic heating, r.f. heating and neutral beam heating to temperatures to cause the nuclei in the plasma to react in order to release energy. As disclosed in U.S. Pat. No. 4,894,199, hereby incorporated by reference, deuterium and tritium nuclei (i.e. deuterons and tritons) are commonly known reactants. The fusion of such reactants are known to produce an alpha particle and a neutron and release more than 17 MeV in energy; about 14 MeV in the form of the kinetic energy of the neutron and the rest in the form of the kinetic energy of the alpha particle. The energy is commonly captured in a blanket and converted to heat and used to generate useful electricity.

A major problem with such fusion devices lies in confining the plasma long enough for enough reactions to occur to justify the energy needed to operate the devices, of which operation of the confined magnetic fields is a large part. Among such devices are those of toroidal geometry, such as tokamaks, and those of linear geometry, such as mirror machines.

The reaction of hydrogen nuclei (i.e. protons) with boron nuclei has been previously investigated. However, the problem with such a reaction is that a very high ion temperature is required to obtain a modest reactivity. Losses of energy by means of Brehmstralung, the emission of electromagnetic radiation in the collision of fast electrons with nuclei, is proportional to Z³, the cube of the atomic number of the nuclei, and can be expected to be substantial for a large nucleus such as boron with an atomic number of 5. As such, ignition or steady state operation of a reactor based on such a reaction heretofore was known to be a marginal possibility at best.

### SUMMARY OF THE INVENTION

The present invention is directed to a fusion device and method and in particular to a fusion reactor which utilizes a proton beam and a beam of ionized boron that are injected into a colliding beam field-reversed configuration system at velocities and temperatures which take advantage of a resonance the fusion cross-section of the boron-proton reaction, 0.65 MeV having a width of about 100 keV. One proton and one boron nucleus fuse to produce three alpha particles with kinetic energies convertible to useful energy. As will be discussed in more detail below, the reaction is stable and is capable of steady-state operation.

The beams are neutralized with the addition of electrons and subsequently directed into a substantially constant unidirectional magnetic field in a reaction chamber. The beams are introduced perpendicular to the direction of the magnetic field and thus acquire an electric self-polarization due to the magnetic field. The polarization is thereafter drained due to electron conductivity along the magnetic field lines when the beams reach the interior of the chamber so that the beams are trapped in the magnetic field. More particularly, the drained beams are trapped to move in circular orbits, as in a betatron. The orbiting ions generate an electric current, which in turn produces a poloidal magnetic field with field reversal. Fusion reactors with a field-reversed configuration are discussed in detail in “Field-Reversed Configurations with a Component of Energetic Particles”, by J. M. Finn and R. N. Sudan, Nuclear Fusion, Vol. 22, No. 11 (1982), hereby incorporated by reference. The velocities of the ions and the intensity of the magnetic field cause the ions to remain in orbit within the chamber. The ion beams circulate in the same direction around a toroidal coil located at the center of the chamber for purposes of stabilizing the plasma current.

The ions are advantageously injected with energies which substantially optimize the cross-section for their mutual reaction. In particular, the beam velocities are selected such that the relative velocity is substantially equal to a resonance of the boron-proton reaction. For example, the beam velocities may be selected such that the proton beam has an energy of 1 MeV while the ionized boron beam has an energy of about 0.412 MeV, such that the relative velocity of the beams has an energy of about 0.65 MeV: the resonance point for the cross-section of the proton-boron fusion reaction. However, the ion beams must have a temperature below 100 keV to take advantage of the resonance.

The fuel is injected in short pulses in order to avoid substantial changes in the energies of the fuel due to slowing down by electrons. This also avoids heating the electrons and accompanying Brehmstralung energy losses from the system.

Because the beams are moving in the same direction at high velocity and rapidly form drifted Maxwell distributions, collisions between the ions as the beams orbit do not change the distributions or the mean velocities of the ion beams. Moreover, with such a configuration, the ions remain at useful temperatures at the selected energies and confined for relatively long periods, permitting the desired reactions to occur before the ions are lost from the beams or their temperatures drop below a useful temperature.

In the present invention a low-density, cool plasma may be introduced into the reaction chamber for the sole purpose of draining the polarization of the polarized ion beams at the start of injection of the ion beams. Thereafter, the electrons associated with the trapped beams themselves drain the later entering portion of the beams.

Advantageously, a significant portion of the reaction products rapidly escape magnetic confinement, and the remaining portion heat the fuel ions and electrons and escape by scattering.

Prior reactor configurations involving beams of energetic particles and conventional high density, low energy target plasma have had their theoretical energy gain limited to about 3-4 because the energetic particles lost energy to the plasma too rapidly and spent too little time at an energy level where the fusion cross section was high. Because of the high energy positive hot ion beams used in the present invention, the proton beam reacts spontaneously with the boron beam to produce a fusion reaction. The ion distributions of the beams are drifted Maxwell distributions which do not change because of collisions. The relative energy due to the beam velocities is critical for the fusion reaction, and this parameter can be selected to give a large reaction rate by operating at the disclosed beam energies, providing the optimum cross section for mutual reaction.

Another advantage of the invention is that the ions are brought to an appropriate energy level and density outside the magnetic containment device by the injection system. It is known that it is practically impossible to build up either the density or the energy of a plasma within a magnetic trap without passing through many instabilities. Therefore, the plasma must be forced to pass rapidly through the instabilities to prevent the instabilities from hindering the process. In order to avoid this problem, the ions at high density and energy levels are generated outside the magnetic trap in the present invention. The method of injection and trapping of the ions described below insure that the instabilities are passed through rapidly. Thus, an operational point for the reactor may be found between such instabilities.

The ion beams are generated at high densities and energies and then neutralized by picking up electrons to produce intense neutralized beams. The fully neutralized beams propagate across the magnetic fields of the containment geometry by means of self-polarization and ExB drift. When the polarized beams reach plasma, the polarization of the electrons is drained rapidly because the plasma is a good conductor. Thereafter, the beam ions move in a manner determined by the prevailing magnetic fields of the containment device which produces a trapping of the beams within the containment area.

The confining field is a substantially constant unidirectional magnetic field directed normal to the ion beams, thus eliminating the need of a large toroidal magnetic field for stability since under the influence of the field, large orbit encircling particles do not follow field lines. Thus, the Kruskal-Shafranov limit is not applicable, and it is not necessary for stability to generate the large toroidal magnetic field, such as in tokamak-type reactors. The energy investment in this magnetic field is no longer necessary. The field is azimuthally symmetrical and unidirectional over the trapping region and preferably converges outside this region to keep the orbits in the region.

### BRIEF DESCRIPTION OF THE DRAWING

These and other objects of the present invention will be readily understood upon consideration of the following detailed description and attached drawing, wherein:

FIG. 1 is a graph of the proton-boron nucleus reaction cross-section as a function of proton energy;

FIG. 2 is a graph of the average of the proton-boron nucleus cross-section and relative velocity over velocity distributions as a function of kinetic temperature;

FIG. 3 is a partial sectional view in perspective of the fusion device in accordance with the present invention;

FIG. 4 is a diagrammatic illustration of magnetic flux surfaces for the field-reversed configuration of the present invention;

FIG. 5 is a graph of density profiles of electrons, protons and boron ions as a function of radial distance in the reaction chamber;

FIG. 6 is a graph of the magnetic field as a function of radial distance in the reaction chamber;

FIG. 7 is a graph of the electrostatic potential as a function of radial distance in the reaction chamber;

FIG. 8 is a diagrammatic end-view of particle pathways in the magnetic field of the reaction chamber; and

FIG. 9 is a diagrammatic end-view of particle distributions in the reaction chamber.

### DETAILED DESCRIPTION OF THE INVENTION

The nuclear fusion reaction of a proton and a boron nucleus, yielding three alpha particles or helium nuclei, ideally generates about 8.68 MeV of energy:

p+B¹¹→3He⁴+8.68 MeV (1)

The reaction has heretofore been known to have several problems. In particular, relatively high ion temperature is required to achieve even modest reactivity. For example, to achieve <σv>=2×10⁻¹⁶ cm³/sec, (where σ is cross-section and v is relative velocity) a kinetic temperature of 300 keV is required. Furthermore, radiative energy losses due to Brehmstralung are high due to the relatively large atomic number of boron, Z=5.

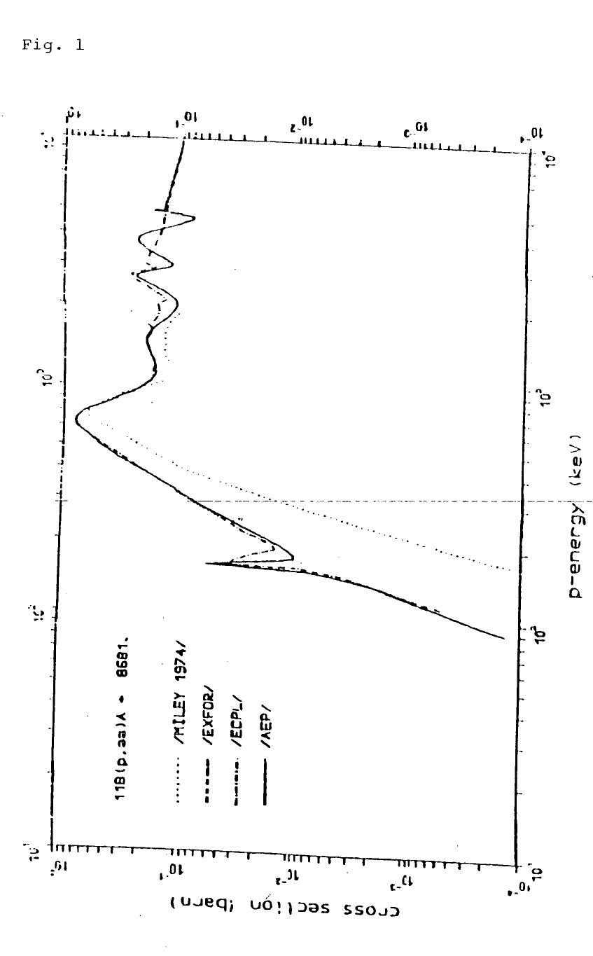

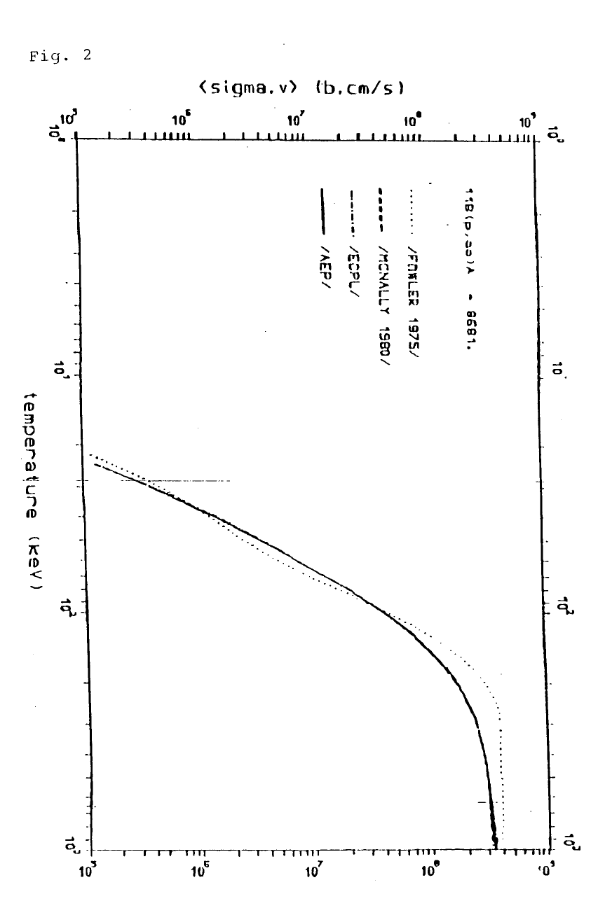

Turning to FIG. 1, a graph of pB¹¹ reaction cross-section as a function of proton energy reveals a maximum cross-section, or resonance, around 0.65 MeV. The width of this resonance is about 100 keV. Within this energy width, σ is approximately 7×10⁻²⁵ cm² and v is about 1.13×10⁹ cm/sec so that σv is about 7.9×10⁻¹⁶ cm³/sec; close to the peak thermal average <σv> for a deuterium-tritium reactor. The value <σv> for the pB¹¹ reaction is shown as a function of temperature in FIG. 2.

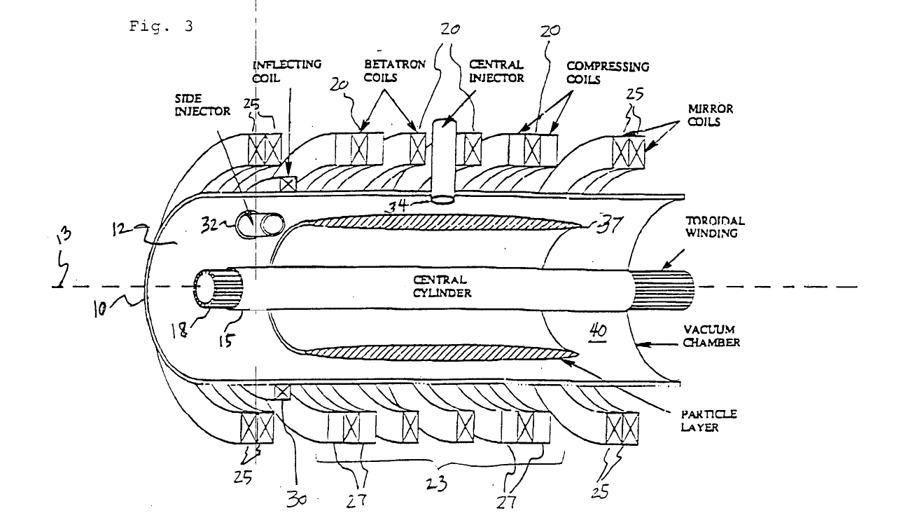

According to the invention, beams of protons and boron ions, neutralized with electrons, are injected into a chamber shown in the device of FIG. 3 with appropriately chosen energies and temperatures to react at the resonance cross-section (i.e. 0.65 MeV). High energy protons and boron ion beams of a pulsed nature may be generated, for example, with ion diodes and Marx generators as disclosed in Rostoker U.S. Pat. No. 4,894,199 hereby incorporated by reference. Since a neutralized ion bean has an equal number of comoving positive ions and electrons, the resultant beam is electrically neutral and has no net current or charge. In one embodiment of the present invention, protons are accelerated to about 1 MeV and boron ions are accelerated to about 0.412 MeV utilizing accelerators commonly known by those of ordinary skill in the art. The particle beam current for the protons is about 0.294×10⁵ A/cm², while the particle beam current for the boron is about 1.22×10⁵ A/cm² during steady-state operation of the device. Fuel is injected in pulses every 1 millisecond, having 11.5 A/cm in each pulse. Both beams are preferably injected at a temperature of about 70 keV.

The polarization of a neutralized ion beam occurs where there are equal numbers of positive and negative charges moving orthogonally to a relatively uniform magnetic field. The positive charges are high energy and high density ions of a nuclear reactant, and the negative charges are neutralizing electrons, added to the nuclear reactants prior to injection into the reaction chamber. This neutralized beam is transported across the magnetic containment field without deflection according to the well known polarization effect described in U.S. Pat. No. 4,548,782. The magnetic field acts on the oppositely charged particles in opposite directions, but the resulting space charges attract, leaving the neutralized beam intact but polarized.

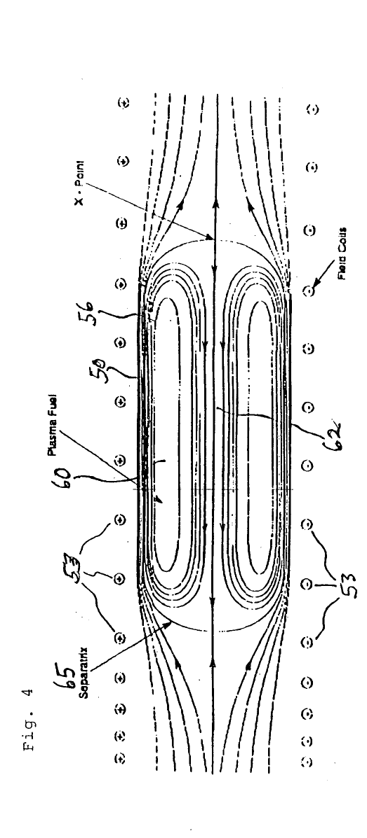

Turning to FIG. 3, a preferred configuration for a fusion device of the present invention, a reaction chamber wall 10 is shown having a substantially cylindrical shape, defining a confining reaction chamber 12 with a longitudinal or principal axis 13. Concentric to the axis of the chamber 12 is a central cylinder 15 having a toroidal coil 18 for generating a toroidal magnetic field to control precessional mode instability in the ion current. The toroidal magnetic field is not intended to be the containing force on the plasma, and therefore need not be as strong as a typical toroidal magnetic field in a tokamak reactor. Betatron coils 20 produce a relatively constant magnetic field with field lines extending axially along the longitudinal axis of the chamber 12. The field is azimuthally symmetrical and axial over a confinement region 23. Mirror coils 25 are more closely spaced together than betatron coils 20, and are located at the ends of the reaction chamber 12 to produce a stronger field with more windings than the field in the confinement region 23, thereby providing a closing effect at the ends of the annular confinement area 23. Compression coils 27 and an inflecting coil 30 are also used to produce the magnetic flux distribution illustrated in FIG. 4.

Separate injector ports are provided for each of the nuclear reactant ion beams. A side injector 32 allows for injection of boron ions, while a central injector 34 is used to inject the protons. Of course, it is contemplated that more injectors may be used for the injection of the ion beams.

An ion layer 37 can be built up and maintained by injecting repetitive pulses of protons and boron nuclei from ion diodes (not shown) firing through respective ion injection channels 32 and 34. At start-up, a plasma gun (not shown) may be used to introduce a plasma 40 of cool, low-density ions into the reaction chamber 12 to provide for draining of the polarization of the beams. The energization of the plasma gun and the ion diodes may be synchronized by suitable timing systems (not shown) commonly known in the art. The plasma gun may be a discharge device emitting a beam of protons along the magnetic field lines.

After start-up, a circulating ion current quickly forms and stabilizes in a confinement region 23, which generates its own magnetic field, resulting in the field-reversed configuration, shown diagrammatically in FIG. 4. Azimuthally symmetric axial magnetic field lines 50, generated by field coils 53, surround poloidal field lines 56 generated by the circulation of plasma fuel ion current 60. Within the torus of the plasma current 60, the poloidal field lines 62 are directed opposite to the magnetic field lines 50. A separatrix 65 forms a boundary between magnetic field lines following lines 50 and those of the poloidal field 60 and 62. Within the plasma current 60, the magnetic flux goes to zero. The field coils 53 become more closely spaced at each end of the system, providing a magnetic pinching which tends to confine the plasma current 60 in the confinement region.

In accordance with an important aspect of the invention, the high-density, energetic ions of the proton and ionized boron beams are introduced at different mean velocities and confined to move together in the same direction. As such, spontaneous fusion reaction results without ignition because in the reference frame of the boron nuclei, the protons have the optimal resonant energy of 0.65 MeV for maximum cross-section as long as the beam temperatures are less than 100 keV to take advantage of this resonance. In contrast, in the case of tokamak reactors using deuterium and tritium, it is necessary to contain the resulting 3.5 MeV alpha particles to preserve their energy for ignition. In order to contain 3.5 MeV alpha particles, the minor radius of the tokamak must be at least 10 times the gyro-radius of the alpha particles, which is 10.7 cm in a magnetic field of 50 kG. For this and other reasons, a tokamak reactor with ignition must be very large.

It is possible with the present invention to produce net energy without achieving ignition. The high energy ion beams are injected, trapped and confined so that scattering, known to be more frequent than fusion, will not quickly lead to the loss of the high energy ions or the energy investment in the beam. Because they circulate as a plasma current in the same direction at high velocity, collisions between the ions as the beams orbit do not change the distributions or the mean velocities of the ion beams. Thus, the nuclear reactants remain at the desired energies and confined for relatively long periods, permitting the desired reactions to occur before the ions are lost from the beams or their temperatures drop below a useful temperature.

One example of the steady-state operation of the reactor of the present invention is disclosed below. For simplicity, a simplified model is used with a configuration of an infinitely long cylindrical reaction chamber so that the system may be treated in one dimension. In the model the coordinate of the long axis of the reaction chamber is assumed to be the z-axis, while the one-dimensional view of the magnetic and electric fields and particle position as being on radius r extending from the z-axis. The azimuthal angle is θ.

It is anticipated that the ion beams will rapidly develop and stabilize in Maxwellian energy distributions. Such a distribution function is of the form

where if <v_{θ}>=−ωⱼr the distribution is a rigid rotor distribution (ω is generally the angular velocity). The electron temperature Tₒ is not equal to the temperature for ions Tᵢ. A particle density nⱼ is of the form

$${n}_{j} = {n}_{oj} exp [ \frac{{{m}_{j} ( {ω}_{j} r )}^{2}}{2 {T}_{j}} - \frac{{e}_{j} Φ}{{T}_{j}} - \frac{{e}_{j} {A}_{θ} {ω}_{j} r}{{cT}_{j}} ] \qquad ( 3 )$$

where Φ and A_{θ} are potentials. The electric and magnetic fields are given by E=−∇Φ and B=∇×(A_{θ}θ). The equilibrium solution of the Vlasov-Maxwell equations is obtained by solving simultaneously

$$∇ \times \vec{B} = \frac{4 π}{c} \sum {n}_{j} {e}_{j} r {ω}_{j} \dot{θ} \qquad ( 4 )$$

and

Σnⱼeⱼ=0. (5)

The latter equation merely indicates the total charge of the system is neutral. If a particle density nⱼ depends on r and z, numerical methods are required to solve the system of equations. If nⱼ depends only on r, analytical solutions can be obtained. For distribution functions like Eq. (2), the Vlasov equation can be replaced by the fluid equations for conservation of momentum:

$$\begin{matrix}- {n}_{j} {m}_{j} r {ω}_{j}^{2} = {n}_{j} {e}_{j} ( {E}_{r} - \frac{r {ω}_{j}}{c} {B}_{z} ) - {T}_{j} \frac{ⅆ {n}_{j}}{ⅆ r} & ( 6 ) \\ {n}_{e} = {\sum }_{i}^{} {n}_{i} {Z}_{i} & ( 7 ) \\ \frac{ⅆ {B}_{z}}{ⅆ r} = \frac{4 π er}{c} [ {\sum }_{i} {n}_{i} {Z}_{i} {ω}_{i} - {n}_{e} {ω}_{e} ] . & ( 8 )\end{matrix}$$

Σᵢ means the sum is only over ions of charge Zᵢe. Eq. (5) for electrons can be solved for Eᵣ which can then be eliminated from the ion moment equation. After differentiating with respect to r, a differential equation is obtained that involves only densities

$$\frac{{ⅆ}^{2} ln {n}_{i}}{d {ξ}^{2}} = \frac{4 {πZ}_{i} {e}^{2}}{{T}_{i}} [ \frac{{ω}_{e} - {ω}_{i}}{{c}^{2}} ] [ {n}_{e} {ω}_{e} - {\sum }_{i} {n}_{i} {Z}_{i} {ω}_{i} ] + \frac{{Z}_{i} {T}_{e}}{{T}_{i}} \frac{{ⅆ}^{2} ln {n}_{e}}{ⅆ {ξ}^{2}} \qquad ( 9 )$$

with n_{θ}identified by Eq. (7) and ξ=r²/2. An exact solution of a system of Eqs. (9) can be obtained of the form n=Aᵢn_{θ} where Aᵢ are constants. For two ion species

$$\begin{matrix}\frac{{n}_{e}}{{n}_{eo}} = \frac{{n}_{1}}{{n}_{1 o}} = \frac{{n}_{2}}{{n}_{2 o}} = {sech}^{2} ( \frac{ξ - {ξ}_{o}}{\sqrt{2} {D}^{2}} ) & ( 10 ) \\ \frac{1}{{D}^{4}} = \frac{4 π {n}_{eo} {e}^{2}}{{T}_{i}} \frac{{\sum }_{i = 1}^{2} ( {Z}_{i} / {T}_{i} ) ( {ω}_{e} - {ω}_{i} ) ( {ω}_{e} - {\sum }_{i = 1}^{2} {A}_{i} {Z}_{i} {ω}_{i} )}{{\sum }_{1 = 1}^{2} ( {T}_{i} + {Z}_{i} {T}_{e} ) / {T}_{i}} . & ( 11 )\end{matrix}$$

The equilibrium fluid equations (6) are not effected by adding a toroidal magnetic field B_{θ}(r)=B_{θo}(rₐ/r) because the fluid velocity component V_{z}=0. Therefore, the solution to Eq. (11) applies equally well with an azimuthal magnetic field component B_{θ}(r). At the boundaries of the reaction vessel, namely at r=rₐ the central toroidal cylinder, and at r=r_{b} the chamber wall, the solution is the same as Eq. (11) except that the square of the radius of plasma circulation rₒ²=½(r²a +r²b); in this case n(rₐ)=n(r_{b}) which is the appropriate boundary condition. The idealization that the central toroidal coil has a negligible radius, e.g., rₐ→0 is permissible, in which case r_{b}=√2rₒ.

For the pB¹¹ reactor of the present invention, the initial electron density nₑₒ is assumed to be 2×10¹⁵ cm⁻³ and

| | | | |
|---|---|---|---|
| Protons: | (1) p | Z₁ = 1 | A₁ = 4/98 |
| Boron: | (2) B¹¹ | Z₂ = 5 | A₂ = 1/9. |

Further assumptions are:

(½)M₁(rₒω₁)²=1 MeV,

(½)M₂(rₒω₂)²=0.412 MeV,

(½)M₁(V₁−V₂)²=0.65 MeV,

V₁=rₒω₁=1.398×10⁹ cm/sec,

V₂=rₒω₂=0.271×10⁹ cm/sec,

rₒ=30 cm,

ω₁=0.466×10⁸ sec⁻¹,

ω₂=0.903×10⁷ sec⁻¹,

and for electrons ωₑ=0.

In the reaction ¹¹B(p,3α), the net energy produced is

Q₀=(M₁+M₂−3M_{∝})c²=8.68 MeV.

The total reaction energy in the lab frame is

Q=Q₀+½(m₁v²₁)+½(m₂v²)=10.1 MeV.

The energy resulting from the fusion is not equally divided between the three α-particles. The reaction proceeds mainly by a sequential decay, B¹¹(p,α)→Be⁸ and Be⁸→2α. Most of the energy is in the secondary α-particles. A reasonable assumption is that 2 α-particles carry most of the energy. Most of the calculations are not very sensitive to how the energy is distributed at u-particle generation.

During steady-state operation of the reactor, the temperatures T₁, T₂, and Tₑ corresponding to the temperatures of the protons, the boron nuclei and the electrons in the plasma, are determined by energy transfer from the fusion products and from radiation. Preferably, according to the invention, the device should be operated such that the resulting temperatures at equilibrium for the protons and the boron nuclei are both about 70 keV, and for the electrons about 50 keV. The following equilibrium calculation demonstrates the reasonableness of selecting T₁=T₂=70 keV and Tₑ=50 keV. The present invention can also be operated such that other temperatures below 100 keV are maintained in the ion cloud at some equilibrium. However, as discussed above, the ion temperatures should be kept below 100 keV to take advantage of the cross-section resonance. Furthermore, it is desirable to prevent the electrons from being heated by fusion products.

For the data assumed above, D=2.55 cm. The line densities of electrons and ions are

$$\begin{matrix}{N}_{j} = {\int }_{0}^{\sqrt{2} {r}_{o}} {n}_{j} ( r ) 2 π r ⅆ r \\ ≅ 4 π \sqrt{2} {D}^{2} {n}_{oj} = 2 π {r}_{o} Δ {rn}_{oj}\end{matrix} \qquad ( 12 )$$

This defines an effective thickness Δr of the layer of circulating plasma current at a maximum density:

$$Δ r = 2 \sqrt{2} \frac{{D}^{2}}{{r}_{o}} = 0.613 cm \qquad ( 13 )$$

and the line densities work out to be:

Nₑ=2.31×10¹⁷/cm

N₁=1.03×10¹⁷/cm

N₂=0.257×10¹⁷/cm.

The magnetic field in the confinement region may be determined by integrating Eq. (7):

$$\begin{matrix}{B}_{z} ( r ) = {B}_{o} [ 1 + \sqrt{β} tanh ( \frac{ξ - {ξ}_{o}}{\sqrt{2} {D}^{2}} ) ] & ( 14 ) \\ where & \\ β = \frac{16 π {n}_{eo} {T}_{i}}{{B}_{o}^{2}} \frac{( {ω}_{1} {A}_{1} + {ω}_{2} {A}_{2} {Z}_{2} )}{( {ω}_{1} + {Z}_{2} {ω}_{2} )} [ 2 + [ 1 + {Z}_{2} ) \frac{{T}_{e}}{{T}_{i}} ] . & ( 15 )\end{matrix}$$

To identify the magnetic field strength Bₒ at the rₒ, consider the conservation of momentum

$$ρ \frac{{V}_{θ}^{2}}{r} = \frac{\partial }{\partial r} ( P + \frac{{B}_{z}^{2}}{8 π} ) . \qquad ( 16 )$$

By integrating this equation from r=0 to r=√2rₒ and using Eq. (7), Bₒ is to determined to be:

$${B}_{o} = \frac{c}{e} \frac{{( {A}_{1} {M}_{1} {ω}_{1} + {A}_{2} {M}_{2} {ω}_{2} )}^{2}}{( {A}_{1} {M}_{1} + {A}_{2} {M}_{2} ) ( {ω}_{1} {A}_{1} + {ω}_{2} {A}_{2} )} = 2.39 kG \qquad ( 17 )$$

and √β=39.7. The magnetic field at the boundaries r=0 and r=√2rₒ is then given by:

B_{z}(√2rₒ)=Bₒ(1+\sqrt{β})=97.3 kG (18)

B_{z}(0)=Bₒ(1−−\sqrt{β})=92.5 kG. (19)

For this equilibrium state of the reactor, the magnetic self energy is

$$\frac{1}{2} {LI}_{θ}^{2} = {\int }_{0}^{\sqrt{2} {r}_{o}} \frac{{( {B}_{z} - {B}_{o} )}^{2}}{8 π} 2 π r ⅆ r = 197 kJ \text{/} cm . \qquad ( 20 )$$

The plasma or ion current is given by

$${I}_{θ} = e {\int }_{0}^{\sqrt{2} {r}_{o}} ⅆ r {\sum }_{i} {n}_{i} {Z}_{i} ( {ω}_{i} r ) = {I}_{1} + {I}_{2} \qquad ( 21 )$$

and yields for protons

I₁=0.294×10⁵ A/cm² (22)

and for boron nuclei

I₂=1.22×10⁵ A/cm² (23)

From the momentum conservation Eq. (16), the inductance of the ion current is

$$L = \frac{2 π {r}_{o}^{2}}{{c}^{2}} [ 1 - \frac{Δ r}{{r}_{o}} ] = 17.3 µH \text{/} cm . \qquad ( 24 )$$

The stored ion energy is

$${\sum }_{i = 1}^{2} {N}_{i} [ \frac{3}{2} {T}_{i} + \frac{{m}_{i}}{2} {( {r}_{o} {ω}_{i} )}^{2} ] = 19.7 kJ \text{/} cm . \qquad ( 25 )$$

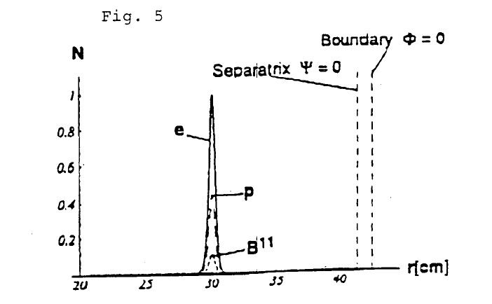

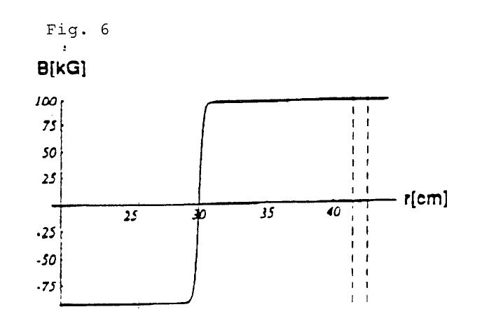

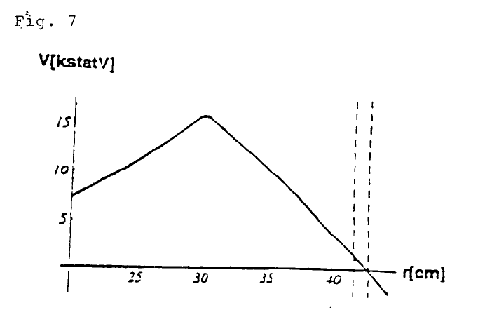

Turning now to FIGS. 5, 6 and 7, the above-calculated steady-state operating conditions yield the density profiles of electrons, protons and boron ions as a function of radial distance from the axis of the reaction chamber in FIG. 5, normalized to the density of the electrons; the magnetic field in kiloGauss as a function of radial distance from the axis of the reaction chamber in FIG. 6; and electrostatic potential in kilo-statvolts as a function of radial distance from the axis of the reaction chamber in FIG. 7. It can readily be seen that the nuclear reactants as well as the electrons, remain largely well confined to the selected injection radius.

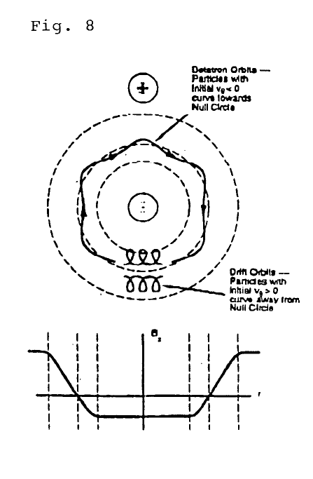

In FIG. 8 typical particle orbits are indicated. Injection of ion beams results in almost all of the fuel ions having v_{θ}<0, which is the diamagnetic direction. Ion paths therefore curve towards the null magnetic field circumference, and are betatron orbits. Particles with v_{θ}>0 exhibit drift orbits, curving away from the null magnetic field circumference. The magnetic field B_{z} is shown in profile in the bottom portion of FIG. 8.

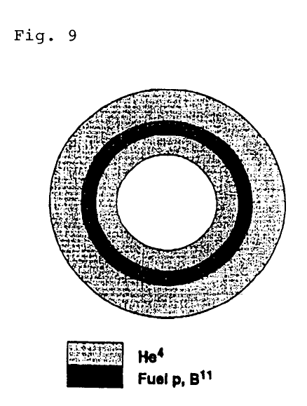

The fusion products are α-particles. It may be expected that two of the three α-particles have most of the energy. They slow down due to interactions with fuel ions and electrons and thus have a distribution which is not Maxwellian. It is reasonable to assume that the average energy of the α-particles is (W_{∝})≅5 MeV. Their distribution in space will extend beyond the fuel ions as indicated in FIG. 9.

If a steady state can be maintained with the equilibrium parameters the fusion power will be

$$\begin{matrix}{P}_{N} = {\int }_{o}^{\sqrt{2} {r}_{o}} {n}_{1} {n}_{2} ( σ {v}_{rel} ) Q 2 π r ⅆ r \\ = \frac{8 π}{3} \sqrt{2} {D}^{2} Q ( σ {v}_{rel} {n}_{1 o} {n}_{2 o} \\ = 19.4 kW \text{/} cm\end{matrix} \qquad ( 26 )$$

and the Bremstrahlung power will be

$$\begin{matrix}{P}_{B} = 9.3 \times {10}^{- 14} \times 1.6 \times {10}^{- 22} ⟨ Z ⟩ \sqrt{{T}_{e}} {\int }_{o}^{\sqrt{2} {r}_{o}} {n}_{e}^{2} 2 π r ⅆ r \\ = 3.88 kW \text{/} cm\end{matrix} \qquad ( 27 )$$

where Tₑ is in electron volts and

$$⟨ Z ⟩ = \frac{{\sum }_{i} {A}_{i} {Z}_{i}^{2}}{{\sum }_{i} {A}_{i} {Z}_{i}} . \qquad ( 28 )$$

It can readily be seen that es are small compared to the power output of the reaction, according to the above computation.

The system of the present invention exhibits stability. Large orbit ions such as those in the present invention tend to average fluctuations so that transport is produced only by fluctuations of wavelength larger than the gyro-radius. This explains the results with non-adiabatic ions in tokamak reactors. For the plasmas of the present invention where essentially all ions are non-adiabatic, micro-instabilities are not important. Long wavelength stability is required but it should be noted that there are no magnetohydrodynamic (MHD) instabilities, such as Alfven waves since magnetohydrodynamics does not apply. Two long-wavelength instabilities are recognized for field-reversed configurations: the rotational kink mode that has been eliminated with quadrupole windings; and the tilt mode that is stabilized by finite gyroradius. It is possible that both modes may be stabilized by energetic particles. Experiments with large orbit axis encircling configurations of electrons have been carried out with and without field reversal. In both cases a central conductor providing a toroidal magnetic field was essential for stabilization of precession and kink modes. Such a field does not effect the equilibria discussed herein. However, it has a considerable effect on the particle orbits and therefore on stability.

The test particle method to evaluate slowing down and diffusion is based on the Fokker-Planck collision operator, where one particle is singled out and the remainder of the particles have Maxwell distributions.

$${( \frac{\partial {f}_{i}}{\partial t} )}_{c} = - \frac{\partial }{\partial \overline{v}} \cdot {{f}_{i} ( Δ \overline{v} )}_{i} + \frac{1}{2} \frac{\partial }{\partial \overline{v}} \cdot \frac{\partial }{\partial \overline{v}} \cdot {{f}_{i} ( Δ \overline{v} Δ \overline{v} )}_{i} \qquad ( 29 )$$

[symbol]

Δ\overline{v} [symbol] ᵢ= [symbol] Δv_{∥} [symbol] ᵢ(\overline{v}/v) (30)

[symbol]

Δ\overline{v}Δ\overline{v} [symbol] ᵢ= [symbol] Δv_{∥}² [symbol] ᵢ(\overline{vv}/v²)+ [symbol] Δv_{⊥}² [symbol] ᵢ[1−(\overline{vv}/v²)] (31)

$$\begin{matrix}{⟨ Δ {v}_{∥} ⟩}_{i} = \frac{4 π {( {Z}_{i} {e}^{2} )}^{2}}{{m}_{i}} ln Λ {\sum }_{j} {n}_{j} {Z}_{j}^{2} ( \frac{1}{{m}_{j}} + \frac{1}{{m}_{i}} ) \frac{\partial }{\partial v} ( \frac{1}{v} erf \frac{v}{\sqrt{2} {v}_{j}} ) & ( 32 ) \\ {⟨ Δ {v}_{⊥} ⟩}_{i} = \frac{4 π {( {Z}_{i} {e}^{2} )}^{2}}{{m}_{i}^{2}} ln Λ {\sum }_{j} {n}_{j} {Z}_{j}^{2} [ erf \frac{v}{\sqrt{2} {v}_{j}} + & ( 33 ) \\ \frac{\partial }{\partial v} ( \frac{{v}_{j}^{2}}{v} erf \frac{v}{\sqrt{2} {v}_{j}} ) ] & \end{matrix}$$

where mⱼvⱼ²=Tⱼ, ln Λ≅20, the test-particle is denoted by i and the summation is over all types of field particles. It is convenient to separate the contributions from each type of field particle. For example, the time for scattering through a large angle of particle i of energy Wᵢ by electrons is

$$\begin{matrix}{τ}_{i e} = \frac{{W}_{i}}{{( \partial {W}_{⊥} / \partial t )}_{i e}} & ( 34 ) \\ {where \\ ( \frac{\partial {W}_{⊥}}{\partial t} )}_{ie} = {m}_{i} {⟨ Δ {v}_{⊥}^{2} ⟩}_{ie} & ( 35 )\end{matrix}$$

and (Δv²_{⊥})ᵢₑ means the term in the sum in Eq. (32) due to electrons is the only term retained. The inequalities usually satisfied are vₑ>v, vᵢ where v is the velocity of an ion test particle. The scattering times are as follows

$${τ}_{ee} = \frac{\sqrt{m} {T}_{e}^{3 / 2}}{2 π {n}_{eo} {e}^{4} ln Λ} = {10}^{- 4} sec . \qquad ( 36 )$$

This is the time for the establishment of a Maxwell distribution for electrons. It is considerably shorter than diffusion time or slowing down time. Therefore, the electron distribution function must be close to Maxwellian at all times. The ion-ion collision times are somewhat longer i.e., a factor of about 70 for protons and about 3.4 for B¹¹. However, these times are also much shorter than any other collisional time scales so that the distribution functions depart little from the rigid rotor Maxwell distributions assumed for the equilibrium.

The most important scattering terms are between ions and electrons, and between different kinds of ions. Ion-electron scattering is calculated with the approximation vₑ>>v where v is the ion velocity and mv²ₑ=Tₑ, the electron temperature. Then

$$\begin{matrix}{τ}_{i e} = \frac{3}{2 \sqrt{2 π}} \frac{{m}_{⊥}}{m} \frac{{W}_{i} \sqrt{m {T}_{e}}}{{n}_{e o} {Z}_{i}^{2} {e}^{4} ln Λ} \\ = 7.62 sec for protons \\ = 2.35 sec for {B}^{11}\end{matrix} \qquad ( 37 )$$

where Wᵢ is the ion kinetic energy. Collisions between protons and B¹¹ must also be considered. In this case the appropriate approximation is v>>vᵢ.

$$\begin{matrix}{τ}_{i j} = \frac{{2}^{1 / 2} {W}_{i} {m}_{i}^{1 / 2} ( {m}_{i} {v}_{rel}^{2} / 2 )}{4 π {n}_{j o} {Z}_{j}^{2} {e}^{4} ln Λ} \\ = 1.10 sec for {τ}_{12} \\ = 1.42 sec for {τ}_{21}\end{matrix} \qquad ( 38 )$$

where vᵣₑₗ=v₁−v₂=1.13×10⁹ cm/sec.

When two identical ions collide, there is no diffusion because the center of mass does not change. The average displacement of the center of mass for different particles after a large angle scattering collision is

$$Δ ρ = \vert \frac{{m}_{1} {a}_{1} - {m}_{2} {a}_{2}}{{m}_{1} + {m}_{2}} \vert \qquad ( 39 )$$

where a₁, a₂ are gyro-radii. If m₂>>m₁, Δρ=a₂. For a₁=v₁/Ω₁=1.47 cm and a₂=v₂/Ω₁=0.627 cm, Δρ=0.455 cm. Calculating a diffusion coefficient from both kinds of scattering, for example, yields

$${D}_{2} = \frac{{a}_{2}^{2}}{{τ}_{2} e} + \frac{{( Δ ρ )}^{2}}{{τ}_{21}} = {a}_{2}^{2} [ \frac{1}{{τ}_{2} e} + \frac{1}{{τ}_{21}^{′}} ] \qquad ( 40 )$$

where τ′₂₁=(a₂/Δρ)² τ₂₁=2.7 sec. The gyro-radii have been calculated for a magnetic field of 95 kG, which is the strength of the magnetic field described herein at the boundaries. The diffusion time for B¹¹ is

$${τ}_{D} = \frac{{( Δ r )}^{2}}{{D}_{2}} ≅ 1.25 sec \qquad ( 41 )$$

which compares favorably to the burn time

$${τ}_{B} = \frac{1}{{n}_{io} {σ}_{F} {v}_{rel}} = 1.42 sec . \qquad ( 42 )$$

The slowing down time of an ion by electrons is given by

$$\begin{matrix}\frac{ⅆ {W}_{i}}{ⅆ t} = \frac{{W}_{i}}{{t}_{ie}} & ( 43 ) \\ where \\ {t}_{ie} = \frac{3}{8} \sqrt{\frac{2}{π}} \frac{{m}_{i} {T}_{e}^{3 / 2}}{{n}_{eo} {Z}_{i}^{2} {e}^{4} \sqrt{m} ln Λ} & ( 44 )\end{matrix}$$

t₁ₑ=0.174 sec=0.492×10⁻3 Tₑ^{3/2} (45)<

t₂ₑ=0.0766 sec=0.216×10⁻³ Te^{3/2} (46)

where Tₑ is in keV.

The fusion products—three α-particles with a combined energy of 10.1 MeV—result from the reaction. The α-particles will execute betatron orbits if they are moving in the diamagnetic direction (v_{θ}<0) or drift orbits if v_{θ}>0, as illustrated in FIG. 8. In the center of mass frame of the reacting fuel particles the α-particle velocity distribution should be isotropic so that nearly half of the α-particles are born with v_{θ}>0. In a finite magnetic field configuration as illustrated in FIG. 4, there must be a radial magnetic field at the ends. The Lorentz force F_{z}=−(1/c)v_{θ}Bᵣ is focusing if v_{θ}<0 and defocusing if v_{θ}>0. Particles with v_{θ}>0 will escape confinement promptly. In addition particles with ½m_{∝}v²_{z}~>0.2 MeV will not be contained because the magnetic field is not large enough. Approximately 50% of the α-particles will escape promptly and the remainder will escape on a collisional time scale, and thus will heat the ions and the electrons of the plasma. In addition, since angular momentum corresponding to v_{θ}>0 is lost promptly, the remaining α-particles can transfer momentum to the fuel ions and reduce the rate of slowing down by ion-electron collisions.

If a steady state can be maintained, approximately one half of the fusion energy will be released promptly in the form of α-particles which are available for direct conversion to useful energy in a blanket or the like. This would amount to 9.7 kW/cm. The rest of the α-particles heat the fuel ions and the electrons and escape by scattering until v_{θ}>0. In order to maintain a steady state fuel would appear to need to be injected continuously. The rate at which fuel ions are consumed is

$$\frac{\partial {n}_{1}}{\partial t} = \frac{\partial {n}_{2}}{\partial t} = {n}_{1} {n}_{2} ⟨ {σ}_{F} v ⟩ . \qquad ( 47 )$$

After integration over the disk 2πr dr,

$${\dot{N}}_{1} = {\dot{N}}_{2} = \frac{2}{3} {( σ v )}_{F} {N}_{2} {n}_{1 o} \qquad ( 48 )$$

The injection current required to maintain a steady state in the reactor would be

$$I = {\sum }_{i = 1}^{2} {Z}_{i} e {\dot{N}}_{1} = 11.55 mA \text{/} cm . \qquad ( 49 )$$

If the fuel is injected at the design-energy, the power involved to create the injection would be

$${P}_{I} = {\sum }_{i = 1}^{2} {m}_{i} \frac{{( {ω}_{i} {r}_{o} )}^{2}}{2} {\dot{N}}_{i} = 2.71 kW \text{/} cm . \qquad ( 50 )$$

This energy would be recovered, but considering the accelerators to be 50% efficient P_{I} should be considered a loss.

Maintaining a steady state means that the initial equilibrium is not substantially altered by collisions. For example, the lifetime of a B¹¹ ion is 1.42 sec. During this time there must be little diffusion. The diffusion time is 1.25 sec, which satisfies this requirement.

Similarly, the fuel ion energies must not change substantially due to slowing down by electrons—not more than 100 keV in 1.42 sec or the resonance value of (σv)_{F} will not prevail. The classical slowing down is in fact too fast. However, this can be compensated for by injecting fuel in pulses short in duration compared to 1.42 sec; for example, 1 millisec pulses 11.5 A/cm. When the current decays between pulses a radial electric field E_{θ}=−(L/2πrₒ)(dI/dt) will arise. Since L=17.3 μH/cm, this will reduce the slowing down rate from the classical single particle value by at least an order of magnitude.

The density of α-particles produced by the fusion reaction is determined by the reaction rate and the scattering time for the α-particles. When the α-particle is scattered so that v_{θ}>0, it will escape promptly. It is assumed that ½ of the α-particles escape promptly. In a steady state

$$\begin{matrix}{N}_{α} = {\int }_{0}^{\sqrt{2} {r}_{o}} {n}_{α} 2 π r ⅆ r \\ = \frac{2}{3} {N}_{2} {n}_{1 o} {τ}_{α} {⟨ σ v ⟩}_{F}\end{matrix} \qquad ( 51 )$$

where τ_{F}=1.42 sec and

$${τ}_{α} ≅ \frac{{2}^{3 / 2}}{8 π} \frac{{⟨ {W}_{α} ⟩}^{3 / 2} \sqrt{{m}_{α}} g}{{( {Z}_{α} {e}^{2} )}^{2} ln Λ {\sum }_{j} {n}_{j} {Z}_{j}^{2}} \qquad ( 52 )$$

the time for a large angle scattering. <W_{∝}> is the average α-particle energy. The particles have a distribution at birth which is extended by slowing down, with <W_{∝}> assumedly 5 MeV. The calculations based on this are not very sensitive to these assumptions, i.e., it would make little difference if the energy were divided equally among 3 α-particles. The quantity g is a correction factor that is necessary because the α-particle distribution extends beyond the fuel distribution as illustrated in FIG. 9.

The electron and ion temperatures are determined by the transfer of the energy of the fusion products to the fuel ions and electrons. The power transfer from ions to electrons is

$$\begin{matrix}{\sum }_{i} {P}_{ie} = {\sum }_{i} \int ⅆ \overline{x} ⅆ {\overline{y} ( \frac{\partial {f}_{i}}{\partial t} )}_{c} \frac{1}{2} {{m}_{i} ( \overline{v} - \overline{V} )}^{2} & ( 53 ) \\ = {\sum }_{i} {m}_{i} {\int }_{0}^{\sqrt{2} {r}_{o}} 2 π r ⅆ r \int ⅆ \overline{v} {f}_{i} ( \overline{v} ) [ v {⟨ Δ {v}_{∥} ⟩}_{i} + & \\ tr {⟨ Δ \overline{v} Δ \overline{v} ⟩}_{i} - \frac{( \overline{v} \cdot \overline{V} )}{v} & \\ where & \\ {f}_{i} ( \overline{v} ) = {{n}_{i} ( \frac{{m}_{i}}{2 π {T}_{i}} )}^{3 / 2} exp [ - \frac{{m}_{i}}{2 {T}_{i}} {( \overline{v} - \overline{V} )}^{2} ] . & ( 54 )\end{matrix}$$

The expressions for <Δv_{∥}>ᵢ and the like come from Eqs. (29) and (32), and only the electron terms in the sums are retained. The result is

$${P}_{ie} = {N}_{i} \frac{( {T}_{i} - {T}_{e} )}{{t}_{ie}} \qquad ( 55 )$$

where the expression for tᵢₑ is given by Eq. (44) and

t_{αe}=3.76×10⁻³Tₑ^{3/2}g. (56)

Tₑ is in keV. The expression for tᵢₑ is modified by the factor g as in Eq. (46).

The temperatures T₁, T₂ and T₃ are determined by the following equations

$$\begin{matrix}\frac{3}{2} {N}_{1} \frac{ⅆ {T}_{1}}{ⅆ t} = \frac{{N}_{α} ⟨ {W}_{α} ⟩}{{t}_{α 1}} - \frac{{N}_{1} ( {T}_{1} - {T}_{e} )}{{t}_{1 e}} + {S}_{21} sc & ( 57 ) \\ \frac{3}{2} {N}_{2} \frac{ⅆ {T}_{2}}{ⅆ t} = \frac{{N}_{α} ⟨ {W}_{α} ⟩}{{t}_{α 2}} - \frac{{N}_{2} ( {T}_{2} - {T}_{e} )}{{t}_{2 e}} + {S}_{12} sc & ( 58 ) \\ \frac{3}{2} {N}_{e} \frac{ⅆ {T}_{e}}{ⅆ t} = \frac{{N}_{α} ⟨ {W}_{α} ⟩}{{t}_{α e}} + \frac{{N}_{1} ( {T}_{1} - {T}_{e} )}{{t}_{1 e}} + \frac{{N}_{2} ( {T}_{2} - {T}_{e} )}{{t}_{2 e}} - {P}_{B} . & ( 59 )\end{matrix}$$

For a steady state the time derivatives vanish and combining the above equations

$$\begin{matrix}{P}_{B} = {N}_{α} ⟨ {W}_{α} ⟩ [ \frac{1}{{t}_{α 1}} + \frac{1}{{t}_{α 2}} + \frac{1}{{t}_{α e}} ] & ( 60 ) \\ \begin{matrix}{t}_{α i} = \frac{{2}^{3 / 2}}{8 π} \frac{{⟨ {W}_{α} ⟩}^{3 / 2} {m}_{i} g}{{n}_{i o} {Z}_{α}^{2} {e}^{4} \sqrt{{m}_{α}} ln Λ} & & i = 1 , 2\end{matrix} & ( 61 )\end{matrix}$$

so that t_{α1}=0.15 g sec and t_{α2}=0.533 g sec. The terms S₁₂ and S₂₁ describe energy transfer between fuel ions:

$${S}_{12} = - {S}_{21} = \frac{4 \sqrt{2 π} {n}_{2} {e}^{4} ln Λ \sqrt{{m}_{1} {m}_{2}}}{{( {m}_{1} {T}_{1} + {m}_{2} {T}_{2} )}^{3 / 2}} {N}_{1} ( {T}_{2} - {T}_{1} ) \qquad ( 62 )$$

In Eq. (60), N_{∝} depends on ion temperatures because it is proportional to D². P_{B} has similar dependence. N_{∝} depends on the factor g in the same way t_{∝1}, t_{∝2}, and t_{∝e}, so that it cancels. From inductance equation P_{B} can be expressed as 0.478 √Tₑ and can be solved for Tₑ=49.5 keV.

Returning to Eqs. (57) and (58), the fuel ion temperatures can be calculated. They are

$$\begin{matrix}{T}_{1} = {T}_{e} + \frac{{N}_{α} ⟨ {W}_{α} ⟩}{{N}_{1}} \frac{{t}_{1 e}}{{t}_{α1}} + {S}_{21} \frac{{t}_{1 e}}{{N}_{1}} & ( 63 ) \\ {T}_{2} = {T}_{e} + \frac{{N}_{α} ⟨ {W}_{α} ⟩}{{N}_{2}} \frac{{t}_{2 e}}{{t}_{α2}} + {S}_{12} \frac{{t}_{2 e}}{{N}_{2}} & ( 64 )\end{matrix}$$

with the result that T₁≈T₂≈70 keV.

These temperatures demonstrate the viability of the parameters assumed as the basis for the above calculations. Adjustments and control can be accomplished by changing the mix of p and B¹¹.

Numerous modifications and variations in practice of the invention are expected to occur to those skilled in the art upon consideration of the foregoing detailed description of the invention. Consequently, such modifications and variations are intended to be included within the scope of the following claims.

Obviously, many modifications and variations of the present invention are possible in light of the above teachings. Thus, it is to be understood that, within the scope of the appended claims, the invention may be practiced otherwise than as specifically described above.

What is claimed and desired to be secured by Letters Patent of the United States is:

1-8. (Cancelled)

9. A method for causing atomic nuclei in a colliding beam field-reversed configuration reactor having a field-reversed configuration of magnetic fields to react to generate reaction products, the method comprising:
(a) injecting repetitive pulses of beams of boron ions at a first predetermined mean velocity and a predetermined temperature into the field-reversed configuration of magnetic fields in the reactor; and
(b) injecting repetitive pulses of beams of protons at a second predetermined mean velocity and said predetermined temperature into the field-reversed configuration of magnetic fields in the reactor; wherein a relative velocity of the beams of the protons and boron ions corresponds to a reaction energy approximately equal to an optimal resonance energy of a fusion reaction cross-section for a reaction of the protons and boron ions.

10. The method as recited in claim 9, wherein the steps of injecting repetitive pulses of beams of protons and boron ions include injecting said beams of protons and boron ions in a direction perpendicular to field lines of the field reversed configuration of magnetic fields.

11. The method as recited in claim 9, further comprising the steps of neutralizing said beams of protons and boron ions with electrons prior to injecting said beams of protons and boron ions into the field reversed configuration of magnetic fields, and confining said beams of protons and boron ions in orbits within the reactor.

12. The method as recited in claim 9, wherein the first predetermined velocity is selected to correspond to a boron ion energy of about 0.4 MeV.

13. The method as recited in claim 12, wherein the second predetermined velocity is selected to correspond to a proton energy of about 1.0 MeV.

14-31. (Cancelled)
